(19) United States
(12) Patent Application Publication
(10) Pub. No.: US 2002/0122224 A1
(43) Pub. Date: Sep. 5, 2002

(54) Method and apparatus for generating a wavelength division multiplexed signal having a level correction signal

(76) Inventors: Yigal Rappaport, Holon (IL); Nitsan Levy, Qiriat-Ono (IL)

Correspondence Address: MERCHANT & GOULD P.C., P.O. Box 2903, Minneapolis, MN, 55402-0903, US

(21) Appl. No.: 09/749,009

(22) Filed: Dec. 27, 2000

(51) Int. Cl. H04B 10/08; H04J 14/02

(52) U.S. Cl. 359/124; 359/110

(57) ABSTRACT

A method for generating a wavelength division multiplexed (WDM) signal to be propagated over an optical path and to optically amplified by a gain factor, the method including the step of: determining a level of input optical signals of different wavelengths to be multiplexed and sent over the optical path; generating a level correction signal, for compensating for a correlation between the gain factor and the level of the WDM signal; and multiplexing the level correction signal and the optical signals to generate the WDM signal.

### FIELD OF THE INVENTION

The present invention relates to a method and system for generating a wavelength division multiplexed (WDM) signal having a level correction signal, and especially for a method and system for generating a WDM signals having level correction signals within an packet switched WDM network.

### BACKGROUND OF THE INVENTION

Optical amplifiers are known in the art. An optical amplifier receives an optical input signal and amplifies it to generate an amplified optical signal. The gain of an optical amplifier, and accordingly the amplified optical signal level, depend on the input signal level.

Optical amplifiers are used in wavelength division multiplexing (WDM) communication systems for amplifying multiplexed light signals that may include a plurality of light signals having respective different wavelengths. The gain of the optical amplifier is inversely proportional to the number of light signals within the multiplexed signal light. Accordingly, when few light signals exist in a multiplexed light signal they can be over-amplified. The relationship between the optical amplifier gain and the number of light signals within a multiplexed light signal is illustrated in U.S. Pat. No. 5,828,486 of Yoshida. The patent also illustrates an optical amplifier device that controls the gain of an optical amplifier in view of the number of light signals within the multiplexed light signal. The number of light signals is measured by sweeping a variable wavelength band pass light filter at a band including all the wavelengths of the light signals. A main disadvantage of the solution is that it is time consuming.

Packet switched networks and accordingly packet oriented communication protocols, such as but not limited to Internet Protocol IP, form the base of modern communications. The bit rates of modern communication systems exceed 10 Gbps and are expected to rapidly grow in the future.

WDM packet switched networks multiplex a plurality of optical packets, each having a different wavelength, to generate a multiplexed light signal. The multiplexed light signal propagates over an optical path, the path includes passive and active devices such as optical links and optical amplifiers.

The number of optical signals within an optical signal and even the presence of an optical signal within an optical path change at ultra high speed.

Prior art methods of gain control, such as but not limited to feedback based gain control methods, can not compensate for ultra fast changes at the level of WDM signals, especially at packet switched networks.

There is a need to provide a method and apparatus for ultra fast compensating for a correlation between a gain of an optical amplifier and the level of WDM signals provided to the amplifier.

There is a need to provide a method and an apparatus for preventing over-amplifications of noise signals at the absence of multiplexed light signals within an optical path.

There is a need to provide a method for allowing optimal amplification of optical data packets in an ultra fast WDM system.

### SUMMARY OF THE INVENTION

The invention provides an apparatus and method for generating a wavelength division multiplexed (WDM) signal having a level correction signal. The generation of the WDM signal and especially of the level correction signal take place before the WDM signal is provided to an optical path to be amplified by a gain factor. The gain factor of the amplification is usually inversely proportional to the level of WDM signal provided to the optical amplifier. Accordingly, the provision of a level correction signal at the absence of input optical signals lower the gain factor and accordingly prevents over amplification of noise signals.

### BRIEF DESCRIPTION OF THE DRAWINGS

While the invention is pointed out with particularity in the appended claims, other features of the invention are disclosed by the following detailed description taken in conjunction with:

FIG. 1 is a schematic diagram illustrating a packet switched network, according to a preferred embodiment of the invention;

FIG. 2 is a schematic diagram illustrating a portion of a node of the packet switched network of FIG. 1, according to a preferred embodiment of the invention;

FIG. 3-5 illustrate input optical signals of different wavelengths and level correction signal according to preferred embodiments of the invention;

FIGS. 6 illustrate various level correction signal generators, according to preferred embodiments of the invention;

FIG. 7 illustrate an apparatus for generating a WDM signal that includes a level correction signal, according to a preferred embodiment of the invention;

FIGS. 8-9 are flow charts illustrating methods for generating WDM signals that include level correction signal; and

FIG. 10 illustrates input optical signals of different wavelengths and level correction signal according to another preferred embodiment of the invention.

### DETAILED DESCRIPTION OF THE DRAWINGS

It should be noted that the particular terms and expressions employed and the particular structural and operational details disclosed in the detailed description and accompanying drawings are for illustrative purposes only and are not intended to in any way limit the scope of the invention as described in the appended claims.

The invention provides a method for generating a wavelength division multiplexed (WDM) signal to be propagated over an optical path and to optically amplified by a gain factor, the method including the step of: (a) determining a level of input optical signals of different wavelengths to be multiplexed and sent over the optical path; (b) generating a level correction signal, for compensating for a correlation between the gain factor and the level of the WDM signal; and multiplexing the level correction signal and the optical signals to generate the WDM signal.

The invention provides a method for generating a wavelength division multiplexed (WDM) signal to be propagated over an optical path and to optically amplified by a gain factor wherein a level of the level correction signal is inversely proportional to the sum of the levels of the input optical signals.

The invention provides a method for generating a wavelength division multiplexed (WDM) signal to be propagated over an optical path and to optically amplified by a gain factor wherein an average level of the level correction signal during a time period equal to the period of the WDM signal is inversely proportional to the sum of the levels of the input optical signals.

The invention provides a method for generating a wavelength division multiplexed (WDM) signal to be propagated over an optical path and to optically amplified by a gain factor wherein the level correction signal has at least one wavelength that differs from the wavelengths of each of the input optical signals.

The invention provides a method for generating a wavelength division multiplexed (WDM) signal to be propagated over an optical path and to optically amplified by a gain factor wherein a wavelength band of the optical path includes of a first band including all wavelengths of the input optical signals and at least one additional wavelength.

The invention provides a method for generating a wavelength division multiplexed (WDM) signal to be propagated over an optical path and to optically amplified by a gain factor wherein step 1(a) further including a step of monitoring a plurality of predetermined wavelengths corresponding to possible wavelengths of input optical signals to detect a non-active wavelength, and wherein step 1(b) includes a step of utilizing the non active wavelength to convey the level correction signal.

The invention provides a method for generating a wavelength division multiplexed (WDM) signal to be propagated over an optical path and to optically amplified by a gain factor wherein the level correction signal has different characteristics from the characteristics of input optical signals for allowing to differentiate the level correction signal from input optical signals.

The invention provides a method for generating a wavelength division multiplexed (WDM) signal to be propagated over an optical path and to optically amplified by a gain factor wherein the level correction signal includes of predetermined symbols that are being discarded at an end of the optical path.

The invention provides a method for generating a wavelength division multiplexed (WDM) signal to be propagated over an optical path and to optically amplified by a gain factor wherein the level of each input optical signal is constant and the level correction signal compensates for a correlation between the gain factor and between a number of input optical signals within the WDM signal.

The invention provides a method for generating a wavelength division multiplexed (WDM) signal to be propagated over an optical path and to optically amplified by a gain factor wherein each input optical signal carries at least a portion of a data packet.

The invention provides a method for generating a wavelength division multiplexed (WDM) signal to be propagated over an optical path and to optically amplified by a gain factor wherein at least some of the input optical signals are characterized by ultra high bit rate.

The invention provides a method for generating a wavelength division multiplexed (WDM) signal to be propagated over an optical path and to optically amplified by a gain factor further comprises a step of determining an absence of optical signals, and a step of generating a level correction signal such that the amplification of noise signal propagating over the optical path is minimized.

The invention provides a method for generating a wavelength division multiplexed (WDM) signal to be propagated over an optical path and to optically amplified by a gain factor further includes a step of delaying the input optical signals while determining the level of the input optical signals and while generating the level correction signal.

The invention provides a method for generating a wavelength division multiplexed (WDM) signal to be propagated over an optical path and to optically amplified by a gain factor, the method including the step of: (a) determining a level of input optical signals of different wavelengths to be multiplexed and sent over the optical path; (b) generating at least one level correction signal, for compensating for a dependency of the gain factor on the level of the WDM signal; and (c) multiplexing the at least one level correction signal and the optical signals to generate the WDM signal.

The invention provides a method for generating a wavelength division multiplexed (WDM) signal to be optically amplified by a gain factor and to be propagated over an optical path, the method including the step of: (a) monitoring a level of input optical signals at an input interface to determine a the levels of input optical signals of different wavelengths to be multiplexed and sent over the optical path; (b) generating a level correction signal, for compensating for a correlation between the gain factor and the level of the WDM signal; and (c) multiplexing the level correction signal and the optical signals to generate the WDM signal.

The invention provides a method for generating a wavelength division multiplexed (WDM) signal to be propagated over an optical path and to optically amplified by a gain factor5 further including a step of discarding input level correction signals received at the input interface.

The invention provides a method for generating an output optical signal that has a level correction component, the method including the steps of: (a) monitoring a quantity of input optical signals, each of substantially predetermined equal level, at an input interface; (b) generating a level correction signal, for compensating for a correlation between a gain factor and between a level of the output optical signal; (c) multiplexing the input optical signals and the level correction signal to generate the output optical signal; and (d) propagating the output optical signal over an optical path to be optically amplified by the gain factor.

The invention provides a method for generating a wavelength division multiplexed (WDM) signal to be propagated over an optical path and to optically amplified by a gain factor further including a step of discarding input level correction signals received at the input interface.

The invention provides a method for generating a wavelength division multiplexed (WDM) signal to be propagated over an optical path and to optically amplified by a gain factor wherein the level of the level correction signal is inversely proportional to a sum of the levels of the input optical signals.

The invention provides a method for generating a wavelength division multiplexed (WDM) signal to be propagated over an optical path and to optically amplified by a gain factor wherein the level correction signal has a wavelength that differs from all the wavelengths of the input optical signals.

The invention provides a method for generating a wavelength division multiplexed (WDM) signal to be propagated over an optical path and to optically amplified by a gain factor wherein the level of the output optical signal is constant.

The invention provides a method for propagating data payloads from an input node to an output node in a packet switching network, the data payloads being associated to destination addresses, the packet switched network having a plurality of nodes interconnected by links, the method including the steps of: (a) receiving data payloads and selecting corresponding paths through the packet switching network, the selected routs begin at selected links; (b) generating optical labels representative of the selected paths; (c) adding the optical labels to the data payloads, each pair of data payload and associated optical label embedded in the same wavelength to generate an input optical signal; (d) determining a sum of levels of input optical signals to be sent over each selected path; (e) generating a level correction signal, for each selected path for compensating for a correlation between a gain factor of the selected path and a level of a multiplexed optical signal to be sent over the selected path; and (f) multiplexing the level correction signal of each selected path with the input signals destined to the selected path to generate a multiplexed optical signal to be propagated over the selected path.

The invention provides a method for propagating data payloads from an input node to an output node in a packet switching network, the data payloads being associated to destination addresses, the packet switched network having a plurality of nodes interconnected by links, the method further includes a step of receiving arriving optical signals including of data payloads and labels.

The invention provides a method for propagating data payloads from an input node to an output node in a packet switching network, the data payloads being associated to destination addresses, the packet switched network having a plurality of nodes interconnected by links, the method further includes a step of receiving arriving WDM signals having level correction signals, extracting the level corrections signals to generate optical input signals.

The invention provides a method for generating a wavelength division multiplexed (WDM) signal, the method including the steps of: (a) determining a quantity of input optical signals of different wavelengths and of substantially an equal level to be multiplexed and sent over the optical path; (b) generating at least one level correction signal, for compensating for a dependency of the gain factor on the level of the WDM signal; (c) multiplexing the at least one level correction signal and the optical signals to generate the WDM signal; and (d) propagating the WDM signal over an optical path and optically amplifying the WDM signal by the gain factor.

The invention provides a method for generating a wavelength division multiplexed (WDM) signal to be to be sent to an optical amplifier to be optically amplified by a gain factor, the method including the step of: (a) determining levels of input optical signals of different wavelengths; (b) generating a level correction signal, for compensating for a dependency of the gain factor on the levels of the WDM signal; and (c) multiplexing the level correction signal and the input optical signals to generate the WDM signal.

The invention provides a method for generating an output optical signal having a level correction component, the method including the steps of: (a) monitoring a quantity of input optical signals, each of substantially a predetermined level, at an input interface; (b) generating a level correction signal, for compensating for a correlation between a gain factor and between a level of the output optical signal; and (c) multiplexing the input optical signals and the level correction signal to generate the output optical signal; and optically amplifying the output optical signal by the gain factor.

The invention provides a method for generating a wavelength division multiplexed (WDM) signal to be optically amplified by a gain factor and to be propagated over an optical path, the method including the step of: (a) determining a level of input optical signals of different wavelengths to be multiplexed and sent over the optical path; (b) generating a level correction signal, for compensating for a dependency of the gain factor on the level of the WDM signal; and (c) multiplexing the level correction signal and the input optical signals to generate the WDM signal.

The invention provides a method for generating WDM signals in a network node having an input interface for receiving arriving optical signals, the network node being interconnected to a plurality of optical paths, each WDM signal to be propagated over a selected optical path and to be optically amplified by a gain factor, the method including the step of: (a) receiving arriving optical signals, each associated to a destination address; (b) determining the level of each received input optical signal; (c) selecting optical paths to convey the input optical signals, based upon the destination address of each input optical signal; (d) generating a level correction signal for each optical path, each level correction signal for compensating for a correlation between the gain factor and the level an WDM signal to be sent to the selected optical path; and (e) multiplexing the level correction signal and the optical signals to be sent to each optical path to generate the WDM signals.

The invention provides a method for generating WDM signals in a network node having an input interface for receiving arriving optical signals, wherein a level of each level correction signal is inversely proportional to the sum of the levels of the input optical signals to be sent to the same selected optical path.

The invention provides a method for generating WDM signals in a network node having an input interface for receiving arriving optical signals wherein each level correction signal has at least one wavelength that differs from the wavelengths of each of the input optical signals to bent to the same selected optical path.

The invention provides a method for generating WDM signals in a network node having an input interface for receiving arriving optical signals wherein a wavelength band of each optical path includes of a first band including all wavelengths of the input optical signals and at least one additional wavelength.

The invention provides a method for generating WDM signals in a network node having an input interface for receiving arriving optical signals wherein the method further includes a step of monitoring a plurality of predetermined wavelengths corresponding to possible wavelengths of input optical signals to detect a non-active wavelength, and further includes a step of utilizing the non active wavelength to convey the level correction signal.

The invention provides a method for generating WDM signals in a network node having an input interface for receiving arriving optical signals wherein the level correction signal has different characteristics from the characteristics of input optical signals, such as data bearing optical signals, for allowing to differentiate the level correction signal from data bearing optical signals.

The invention provides a method for generating WDM signals in a network node having an input interface for receiving arriving optical signals wherein the level correction signal includes of predetermined symbols that are being discarded at an end of each optical path.

The invention provides a method for generating WDM signals in a network node having an input interface for receiving arriving optical signals wherein the level of each input optical signal is constant and the level correction signal compensates for a correlation between the gain factor and between a number of input optical signals within the WDM signal.

The invention provides a method for generating WDM signals in a network node having an input interface for receiving arriving optical signals wherein each input optical signal carries at least a portion of a data packet.

The invention provides a method for generating WDM signals in a network node having an input interface for receiving arriving optical signals wherein at least some of the input optical signals are characterized by ultra high bit rate.

The invention provides a method for generating WDM signals in a network node having an input interface for receiving arriving optical signals, wherein the method further includes a step of determining an absence of optical signals, and a step of generating a level correction signal such that the amplification of noise signal propagating over the optical path is minimized.

The invention provides a method for generating WDM signals in a network node having an input interface for receiving arriving optical signals further includes a step of delaying the input optical signals while selecting the selected optical path, while determining the level of the input optical signals and while generating the level correction signal.

The invention provides an apparatus for generating a wavelength division multiplexed signal to be propagated over an optical path and to be optically amplified by a gain factor, the apparatus including: (i) an input interface, for receiving arriving optical signals; (ii) optical dividers, coupled to the input interface, for partially dividing arriving optical signals to output a first portion of the arriving optical signals and input optical signals; (iii) photoelectric converters, coupled to the optical dividers, for converting the first portion of the arriving optical signals to electric signals being indicative of the light levels of the input optical signals and of the destination of the input optical signals; (iv) a level correction generator, responsive to control signals from a controller, for generating a level correction signal; (v) a controller, for receiving the electrical signals, determining a level correction signal and providing control signals to the level correction signal generator based upon the determination; and (vi) a multiplexer, coupled to the optical path and to the controller, for receiving and multiplexing the input optical signals and the level correction signal to generate the WDM signal.

The invention provides an apparatus for generating a wavelength division multiplexed signal to be propagated over an optical path and to be optically amplified by a gain factor wherein the level correction generator selected from the group consisting of: (a) tunable optical signal generator; (b) optical signal generator coupled to an tunable attenuator; and (c) a plurality of switched optical signal generators coupled to a combiner.

The invention provides an apparatus for generating a wavelength division multiplexed signal to be propagated over an optical path and to be optically amplified by a gain factor wherein a level of the level correction signal is inversely proportional to the sum of the levels of the input optical signals.

The invention provides an apparatus for generating a wavelength division multiplexed signal to be propagated over an optical path and to be optically amplified by a gain factor wherein an average level of the level correction signal during a time period equal to the period of the WDM signal is inversely proportional to the sum of the levels of the input optical signals.

The invention provides an apparatus for generating a wavelength division multiplexed signal to be propagated over an optical path and to be optically amplified by a gain factor wherein the level correction signal has at least one wavelength that differs from the wavelengths of each of the input optical signals.

The invention provides an apparatus for generating a wavelength division multiplexed signal to be propagated over an optical path and to be optically amplified by a gain factor wherein a wavelength band of the optical path includes of a first band including all wavelengths of the input optical signals and at least one additional wavelength.

The invention provides an apparatus for generating a wavelength division multiplexed signal to be propagated over an optical path and to be optically amplified by a gain factor wherein the controller is further adapted to analyze the electrical signals to detect non-active wavelengths, and to send the level correction signal generator control signals for generating level correction signals having the non active wavelengths.

The invention provides an apparatus for generating a wavelength division multiplexed signal to be propagated over an optical path and to be optically amplified by a gain factor wherein the level correction signal has different characteristics from the characteristics of input optical signals for allowing to differentiate the level correction signal from input optical signals.

The invention provides an apparatus for generating a wavelength division multiplexed signal to be propagated over an optical path and to be optically amplified by a gain factor wherein the level correction signal includes predetermined symbols that are being discarded at an end of the optical path.

The invention provides an apparatus for generating a wavelength division multiplexed signal to be propagated over an optical path and to be optically amplified by a gain factor wherein the level of each input optical signal is constant and the level correction signal compensates for a correlation between the gain factor and between a number of input optical signals within the WDM signal.

The invention provides an apparatus for generating a wavelength division multiplexed signal to be propagated over an optical path and to be optically amplified by a gain factor wherein each input optical signal carries at least a portion of a data packet.

The invention provides an apparatus for generating a wavelength division multiplexed signal to be propagated over an optical path and to be optically amplified by a gain factor wherein at least some of the input optical signals are characterized by ultra high bit rate.

The invention provides an apparatus for generating a wavelength division multiplexed signal to be propagated over an optical path and to be optically amplified by a gain factor that further includes delay units of delaying the input optical signals until the level correction signals are generated.

The invention provides an apparatus for generating wavelength division multiplexed signals to be propagated over optical paths to be optically amplified by a gain factor, the apparatus including: (a) an input interface, for receiving arriving optical signals, each input optical signal destined to an optical path out of a plurality of optical paths extending from the apparatus; (b) optical dividers, coupled to the input interface, for partially dividing input optical signals to output a first and a second components of the input optical signals; (c) photoelectric converters, coupled to the optical dividers, for converting the first components of the input light signals to an electric signals being indicative of the light levels of the first components of the input light signals and of the destination of the input optical signals; (d) optical switch, coupled to the optical dividers and to a control unit, for receiving the second portions of the optical input signals and in response to control signals from the control unit routing the optical input signals to the destined optical paths; (e) a level correction generator, responsive to control signals from a control unit, for generating level correction signals; (f) control means for receiving the electrical signals, selecting selected paths for the input optical signals, determining for each optical path a level correction signal and providing control signals to the optical switch and the level correction signal generator based upon the determination; and (g) a plurality of multiplexers, each multiplexer coupled to an optical path for receiving and multiplexing input optical signals and a level correction signal destined to the optical path for generating the WDM signal.

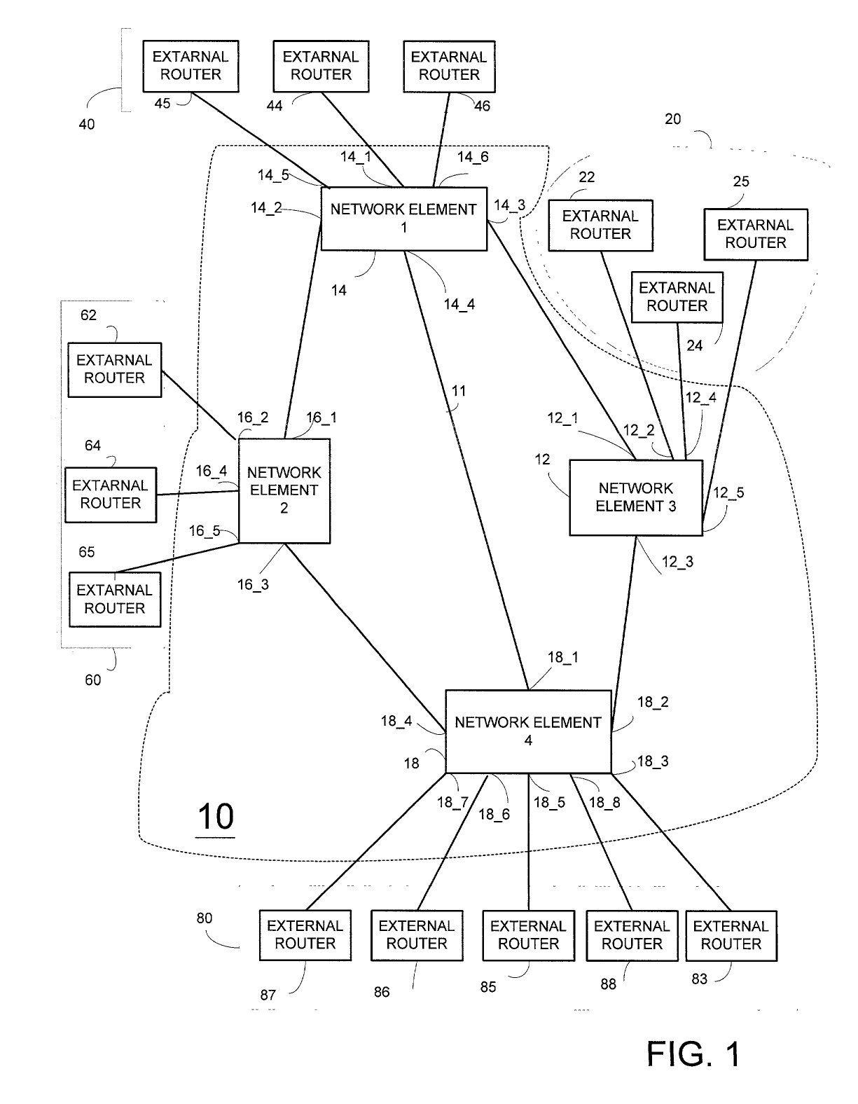

FIG. 1 illustrates packet switched (PS) network 10 interconnecting external networks 20, 40, 60 and 80. PS network 10 has a plurality of nodes such as PS nodes 12,14, 16 and 18. The nodes are interconnected by a plurality of links.

Node 12 has five bi-directional ports 12_1-12_5. Node 14 has six bi-directional ports 14_1-14_6. Node 16 has five bi-directional ports 16_1-16_5. Node 18 has eight bi-directional ports 18_1-18_8. Ports 12_1-12_5 are coupled to port 14_3, external path 22, port 18_2, external path 24 and external path 125 respectively. Ports 14_1-14_6 are coupled to external path 44, port 16_1, port 12_2, port 18_1, external path 45 and external path 46 respectively. Ports 16_1-16_5 are coupled to port 14_2, external path 62, port 18_4, external path 64 and external path 65 respectively. Ports 18_1-18_8 are coupled to port 14_4, port 12_3, external path 83, port 16_3, and external paths 85-88 respectively. External network 40 includes external paths 44, 45 and 46. External network 20 includes external paths 22, 24 and 25. External network 60 includes external paths 62, 65 and 65. External network 80 includes external paths 83, 85, 86, 87 and 88.

For convenience of explanation it is assumed the PS network 10 is an optical network that interconnects external networks having external paths. Other packet switched networks of various topologies and connectivity can be implemented. Various elements can be interconnected to the nodes of PS network 10, such as but not limited to local networks and hosts. Accordingly, each node is configured to receive/send optical signals, such as optical packets, from/to another node. Each node is adapted to receive a plurality of arriving signals from external paths. The arriving signals are either optical or electrical signals and can be representative of data packets. Usually, optical signals such as SONET signals, received from external paths are converted to electrical signals and processed to generate and/or update a label. The electrical signals that are destined to another node are further converted to optical signals.

The nodes of PS network 10 exchange optical signals using Wavelength Division Multiplexing (WDM) techniques. The WDM signals are amplified by a gain factor that is correlated to the level of the WDM signals.

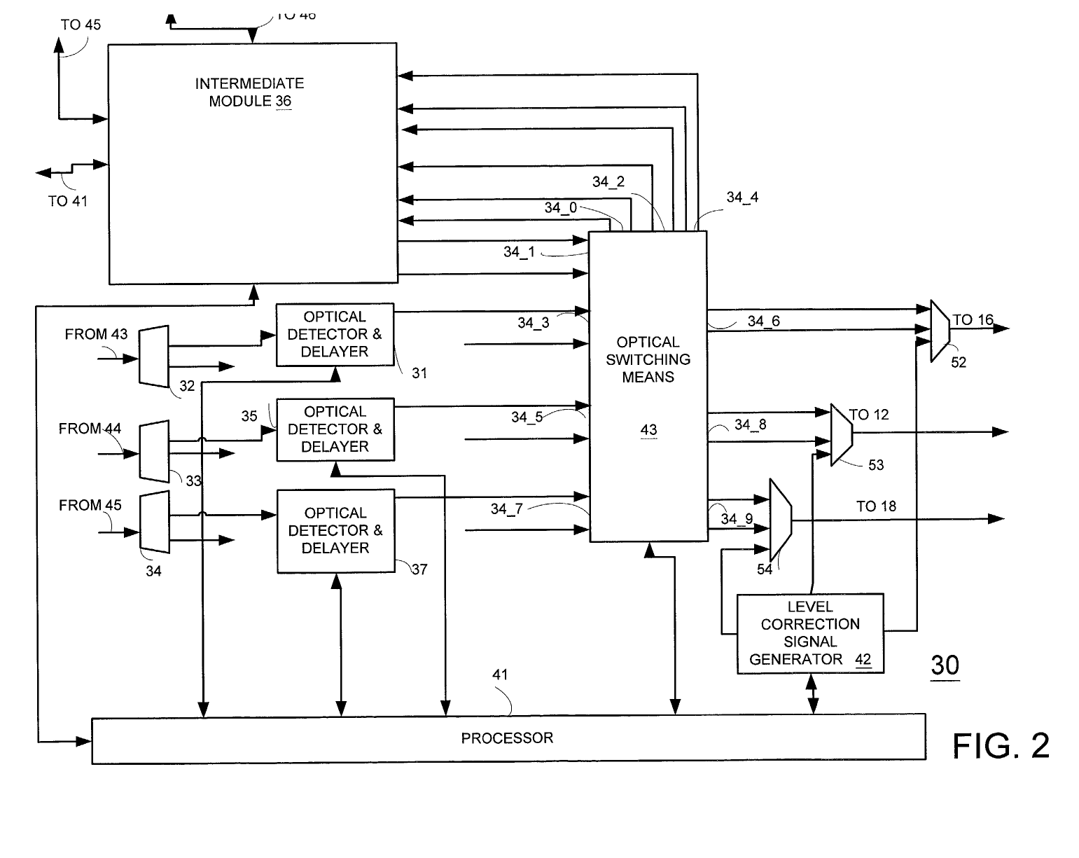

Referring to FIG. 2, there is illustrated portion 30 of node 14 according to a preferred embodiment of the invention. Node 14 has intermediate module 36, optical splitters 32, 33 and 34, optical detectors and delayers 31, 35 and 37, controller 41, optical switch 43, optical combiners 52, 53 and 54, and level correction signal generator 42.

A WDM signal propagates between nodes of PS network 10. The WDM signal is amplified by an optical amplifier that can be located in various locations, such as but not limited to an output interface of a node, an input interface of a node or along a link interconnecting the nodes.

Intermediate module 36 is coupled to external paths 44, 45 and 46 via bi-directional links for receiving and transmitting information payloads such as information payloads encapsulated in a very high frequency SONET frames.

Intermediate module 36 is coupled, via a plurality of links, to group of ports 34_1 of optical switch 43 for providing a plurality of input optical signals. Each link is used to carry a single wavelength.

Intermediate module 36 is adapted to receive arriving signals from external paths having a first format, to process the signals and generate input optical signals to be provided to optical switch 43. Intermediate module 36 is also adapted to receive input optical signals from optical switch 43, to extract the label, to format the signals to the first format to send the signals via the selected exit port to an external path. Usually the input optical signals are used to convey data payload and labels representative of local paths over PS network 10. A label and the data payloads can be transmitted in various manner, such as by utilizing two distinct wavelengths, as illustrated at U.S. patent application Ser. No. 09/686415 filed on Nov. 11, 2000 titled “System and Method for Optical Tag Switching” being incorporated by reference in its entirely.

Optical splitters 32, 33 and 34 receive WDM optical signals having at least one wavelength from another node of network 10 and split the received WDM optical signals to a plurality of arriving optical signals of different wavelengths. The optical splitters can also split arriving optical signals according to their waveband. According to one aspect of the invention, the level correction signal of the arriving WDM signal has a wavelength that differs from the wavelengths of the other components of the arriving WDM signal, so that the level correction signal can be filtered, split or de-multiplexed and ‘dropped’. The arriving optical signals are provided to optical detectors and delayers 31, 35 and 37 that (i) divide each arriving optical signal to a first portion and to an input optical signal; (ii) convert the first portion to an electrical signal representative of the level of the input optical signal and optionally of the label of each arriving optical signal and provide electrical signals indicative of the destination of each arriving optical signal to controller 41; (iii) delay the input optical signals so that level correction signals associated to input optical signals arrive to optical combiners 52, 53 and 54 at substantially the same time.

Optical detectors and delayers provide the delayed input optical signals to groups of ports 34_3, 34_5 and 34_7 of optical switch 43. Optical switch 43, responsive to control signals from controller 41 provides the input optical signals via group of ports 34_0, 34_2 and 34_4 and via intermediate means 36 to external paths 41, 45 and 46. Optical switch 43, responsive to control signals from controller 41 also provides input optical signals via group of ports 34_6, 34_8 and 34_9 and via optical combiners 52, 53 and 54 to optical paths and/or optical amplifiers (not shown).

Optical switch 43 can have a plurality of configurable switches. Optical switch 43 can also have a plurality of tunable wavelength converters coupled to waveband/wavelength selective interconnectors whereas the wavelength/waveband of an incoming optical signal determines the output port from the interconnectors. Controller 41 can either set the plurality of switches or determine the wavelength to be outputted by the tunable wavelength converters.

Intermediate module 36 is also adapted to exchange routing information with other intermediate modules of network 10 and to path optical signals according to optical labels representative of a path through network 10. The label can be updated or generated by intermediate module 36. Usually, the level of input optical signals generated by intermediate module 36, their quantity and destination is known to intermediate module 36. Accordingly controller 41 can calculate their level.

According to another aspect of the invention, the input optical signals have a predetermined level, and the measurement of the level of input optical signals can be simplified by counting the number of input optical signals.

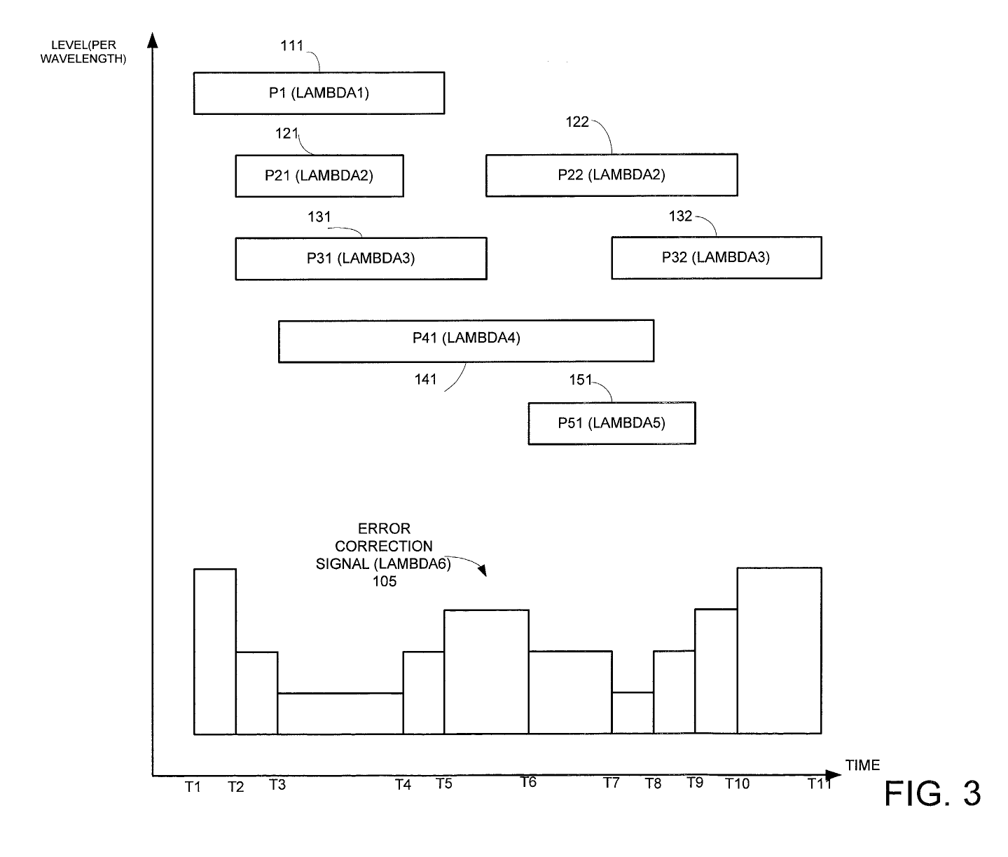

FIGS. 3-5 and 10 illustrate input optical signals and level correction signal to be send over a single optical path. Input optical signals P1 111, P21 121, P22 122, P31 131, P32 132, P41 141 and P51 151, having wavelengths of LAMBDA1, LAMBDA2, LAMBDA2, LAMBDA3, LAMBDA3, LAMBDA4 and LAMBDA5 accordingly are destined to a single optical path. All input optical signals have a same level referred to as LEVEL1. P11 111 starts at T1 and ends at T5, P21 121 starts at T2 and ends at T4, P22 122 starts at T6 and ends at T11, P31 131 starts at T2 and ends at T6, P32 132 starts at T8 and ends at T12 P41 141 starts at T3 and ends at T9, P51 151 starts at T7 and ends at T10.

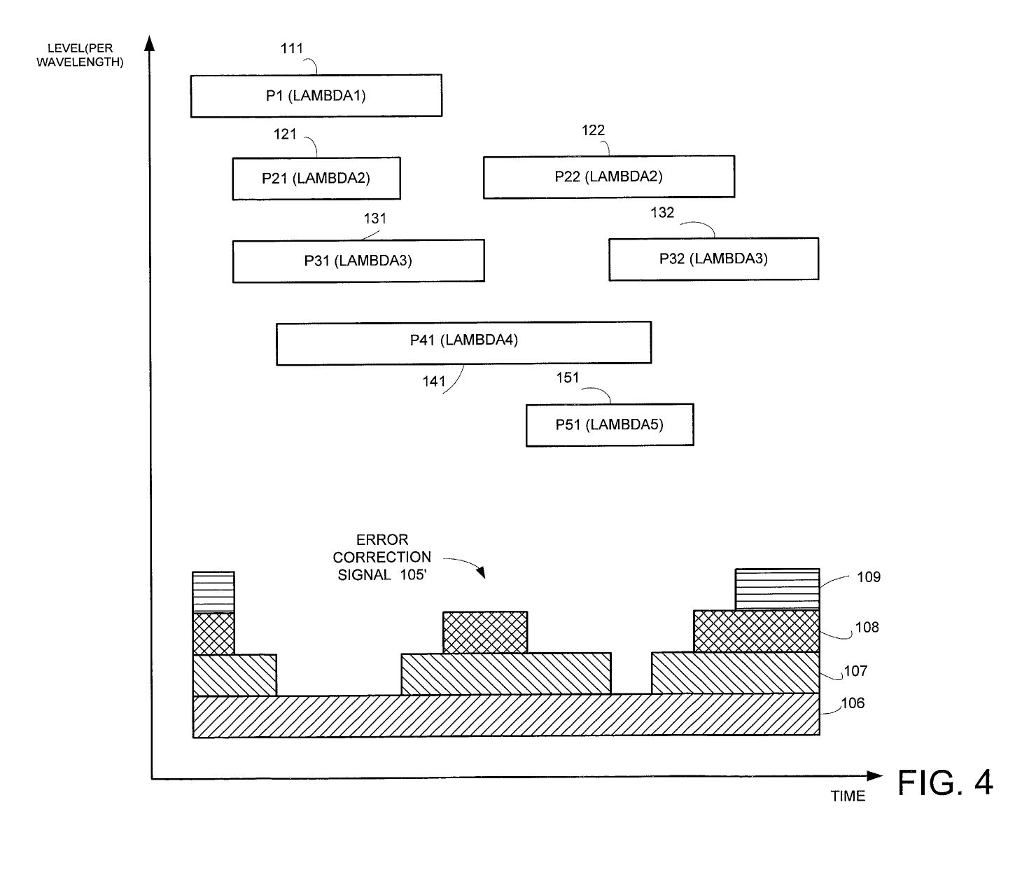

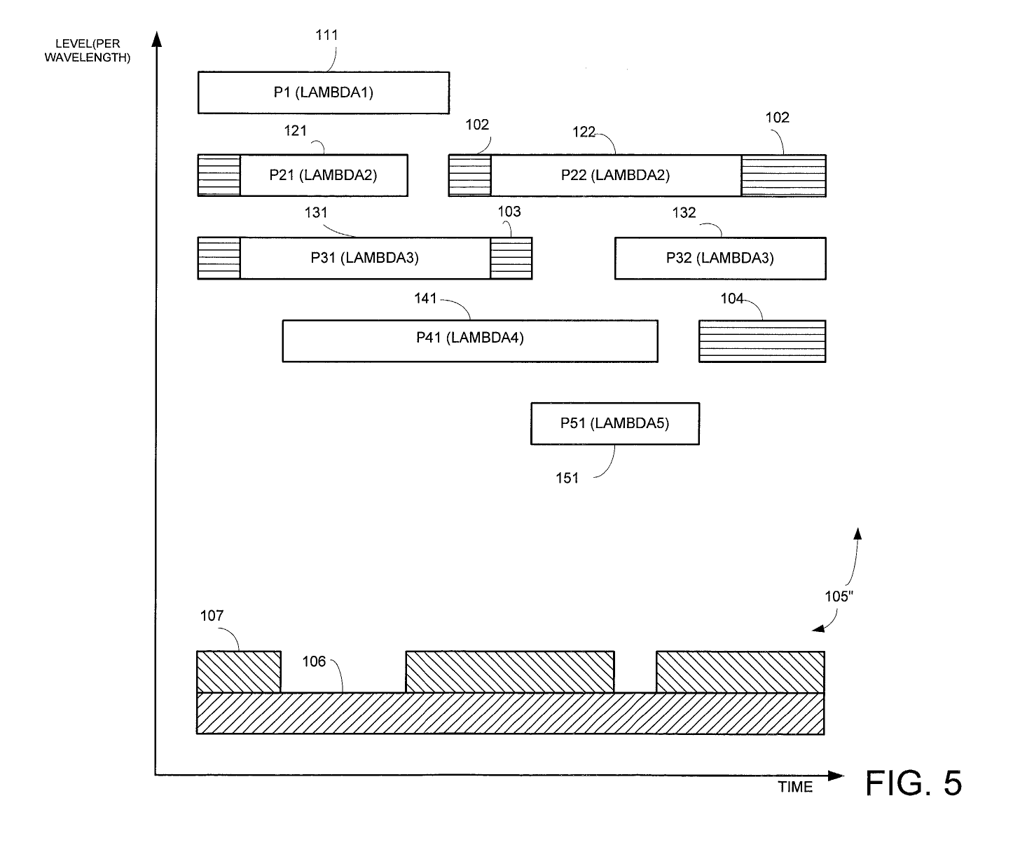

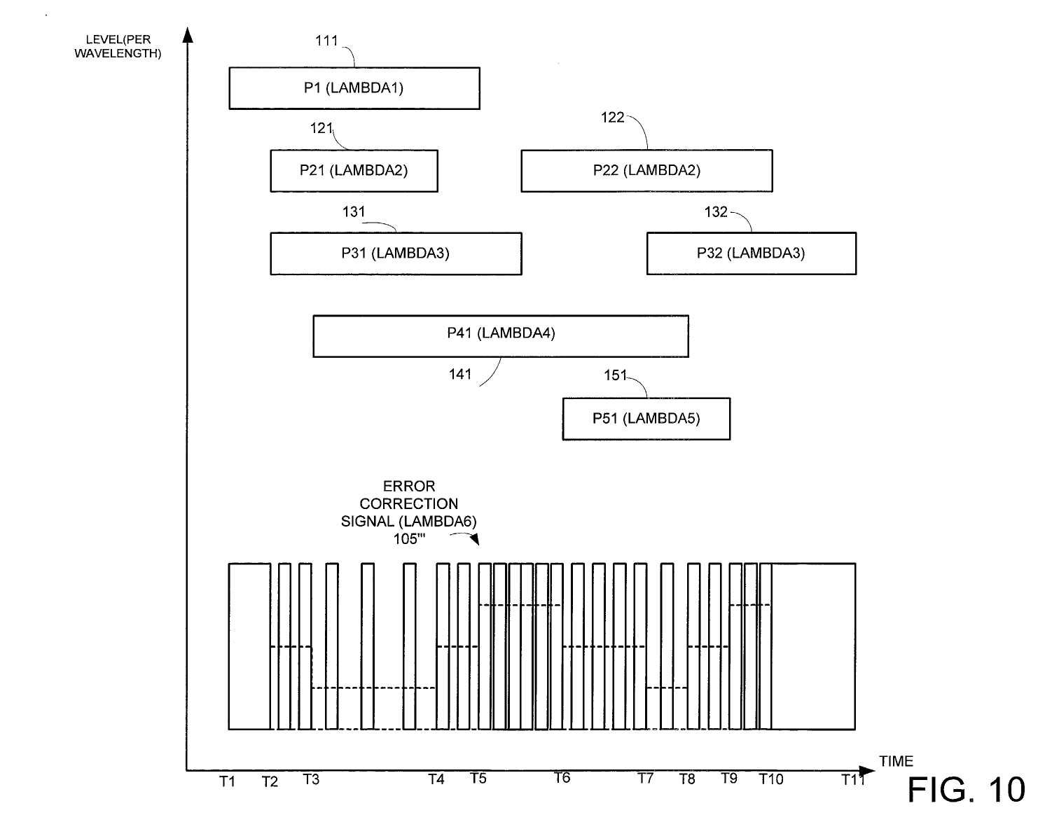

Level correction signal 105 of FIG. 3 has a single wavelength denoted as LAMBDA6. Level correction signal 105′ of FIG. 4 has up to four components of different wavelengths denoted as LAMBDA6, LAMBDA7, LAMBDA8 and LAMBDA9. LAMBDA1-LAMBDA5 differs from LAMBDA6-LAMBDA9. Level correction signal 105″ of FIG. 5 includes IDLE cells having wavelengths of LAMBDA2, LAMBDA3 and LAMBDA4 that are also utilized to convey data packets. Level correction signal 105″ of FIG. 5 further includes components having wavelengths of LAMDBA6 and LAMBDA7. Level correction signal 105″′ of FIG. 10 has a single wavelength denoted as LAMBDA6, but is modulated by a very high-speed modulator to control the average level of the level correction signal 105″′ , the average level of signal 105″′ is illustrates by dashed lines.

Components of level correction signals that have different wavelengths that the wavelength allocated to input optical signals can be added and dropped in the optical domain, without examining the content of the optical signals propagating through the optical network. Components of the level correction signals that have wavelengths that are also used to convey data packets can be removed after the content of at lest a portion of the optical signal is examined. Accordingly, the first type of level correction signals components can be optically filtered or be propagated to a ‘drop’ terminal while the second type of level correction signal requires a conversion of optical signal to electrical signals, an analysis of the electrical signals. Usually, the second type of level correction signal components is removed by intermediate module 36.

Table 1 illustrates the relationship between the input optical signals and the level of the level correction signal that are provided to a single optical path through PS network 10. “SUM” reflects the cumulative level of the optical input signals, LCS reflects the cumulative level of all the components of the level correction signal, and “L” is the level of a single input optical signal.

Table 2 illustrates the various components of level correction signals, according to various embodiments of the invention.

TABLE 1

| | P1 | P21 | P22 | P31 | P32 | P41 | P51 | SUM | LCS |
|---|---|---|---|---|---|---|---|---|---|
| T1-T2 | L | | | | | | | L | 4*L |
| T2-T3 | L | L | | L | | | | 3*L | 2*L |
| T3-T4 | L | L | | L | | L | | 4*L | L |
| T4-T5 | L | | | L | | L | | 3*L | 2*L |
| T5-T6 | | | | L | | L | | 2*L | 3*L |
| T6-T7 | | | L | | | L | | 2*L | 3*L |
| T7-T8 | | | L | | | L | L | 3*L | 2*L |
| T8-T9 | | | L | | L | L | L | 4*L | L |
| T9-T10 | | | L | | L | | L | 3*L | 2*L |
| T10-T11 | | | L | | L | | | 2*L | 3*L |
| T11-T12 | | | | | L | | | L | 4*L |

TABLE 2

| | | | | | | LCS 105″ | | | | |
|---|---|---|---|---|---|---|---|---|---|---|
| | | LCS 105′ | | | | | | LAMB | LAMB | LAMB |
| | LCS | LAMB | LAMB | LAMB | LAMB | LAMB | LAMB | DA4 | DA3 | DA2 |
| | 105 | DA6 | DA7 | DA8 | DA9 | DA6 | DA7 | (IDLE) | (IDLE) | (IDLE) |
| T1-T2 | 4*L | L | L | L | L | L | L | | L | L |
| T2-T3 | 2*L | L | L | | | L | L | | | |
| T3-T4 | L | L | | | | L | | | | |
| T4-T5 | 2*L | L | L | | | L | L | | | |
| T5-T6 | 3*L | L | L | L | | L | L | | | L |
| T6-T7 | 3*L | L | L | L | | L | L | | L | |
| T7-T8 | 2*L | L | L | | | L | L | | | |
| T8-T9 | L | L | | | | L | | | | |
| T9-T10 | 2*L | L | L | | | L | L | | | |
| T10-T11 | 3*L | L | L | L | | L | L | | | L |
| T11-T12 | 4*L | L | L | L | L | L | L | L | | L |

Referring to node 14 of FIG. 2 and to level correction signal 105″ of FIG. 5, controller 41 constantly receives electrical signals from optical detectors and delayers 31, 35 and 37 indicating a presence or absence of input optical signals and of the input optical signals destination. Controller 41 also receives requests from intermediate module 36 to propagate input optical signals being updated and/or generated by intermediate module 36 to their destination. Accordingly, controller 41 determines how to path the input optical signals and accordingly determines the optical level of optical signals to be provided to each optical path at each given moment. Based on this determination controller 41 can calculate a required level correction signal and send control signals to level correction signal generator 42 so that level correction generator 42 generates a level correction signal that compensates for a correlation between the level of a WDM signal propagating over an optical path and the gain factor associated to this optical path. In the example set forth in the mentioned above figures, the level of each input optical signal equals L and the level of each WDM signal equals 5*L. Referring to the time period that ranges between T1 and T2-there is only a single input optical signal P1 111 and accordingly the level of the level correction signal must be 4*L.

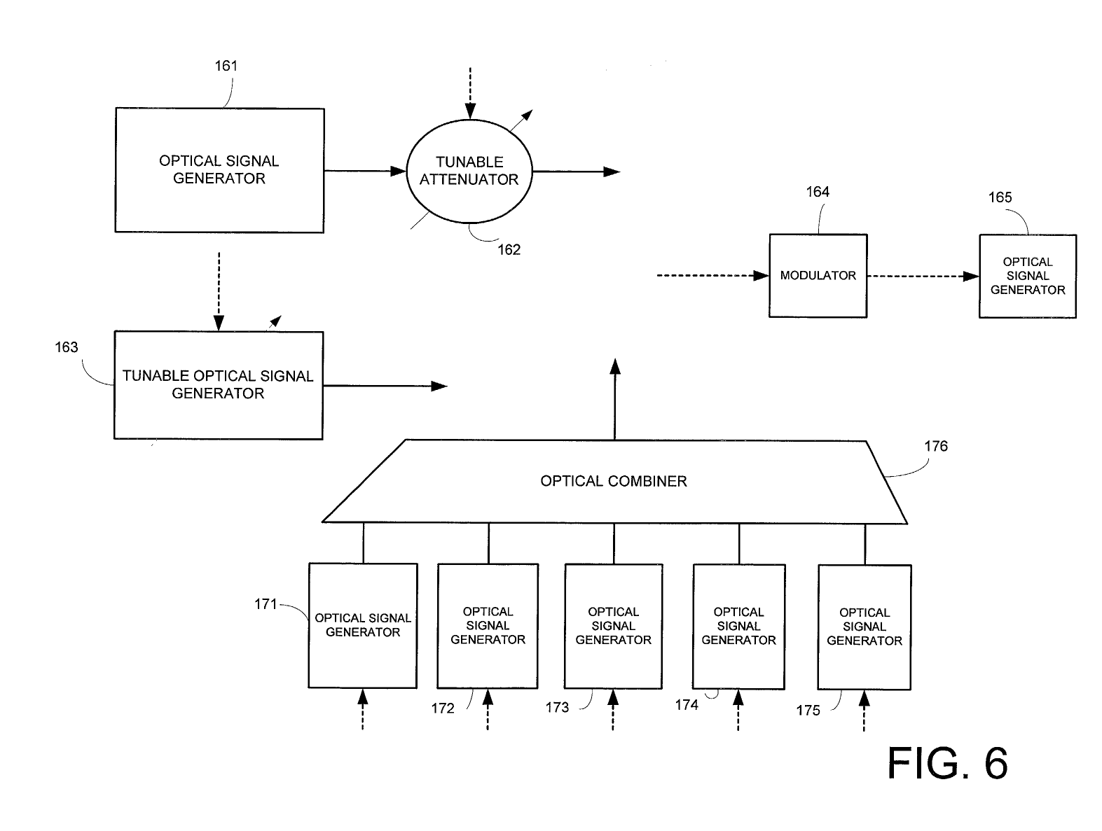

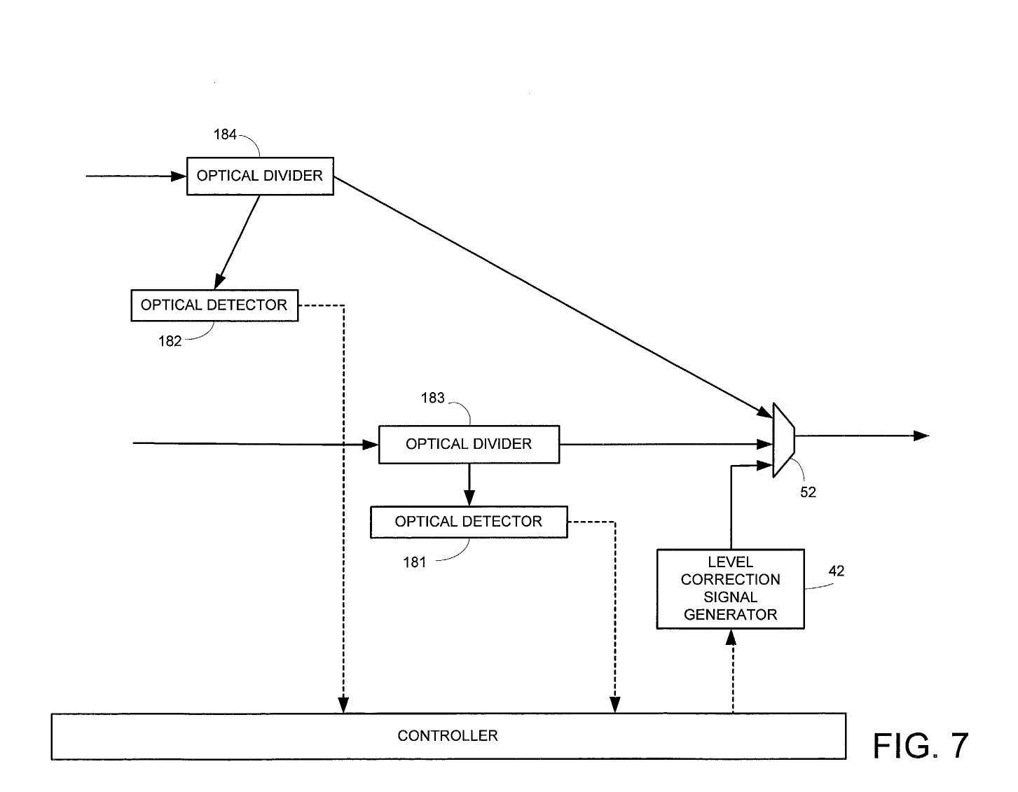

FIG. 6 illustrates some embodiments of level correction signal generator 42 of FIGS. 2 and 7. Level correction signal generator can include at least one of the following units being selected from a group consisting of: (a) Optical signal generator 161 that generates an optical signal of fixed wavelength and level to be provided to an input of tunable attenuator 162 that is responsive to control signals from controller 41 to output a level correction signal of a desired level. (b) Tunable optical signal generator 163 that generates an optical signal of fixed wavelength but of tunable level. Tunable optical signal generator 163 is responsive to control signals from controller 41 to output a level correction signal of desired level. (c) Modulator 164 coupled to optical signal generator 165 for modulating an optical signal to generate a level correction signal of average level that equals the desired level, an exemplary average level signal is illustrated at FIG. 10. (d) A plurality of optical signals generators 171-175, activated by the control signals from controller 41, having their outputs coupled to optical combiner 176 to combine the output signals from activated optical signal generators to produce the level correction signal. Usually, a single optical signal generator generates a monochromatic signal, and accordingly level correction signals having more that a single wavelength include a plurality of optical signal generators.

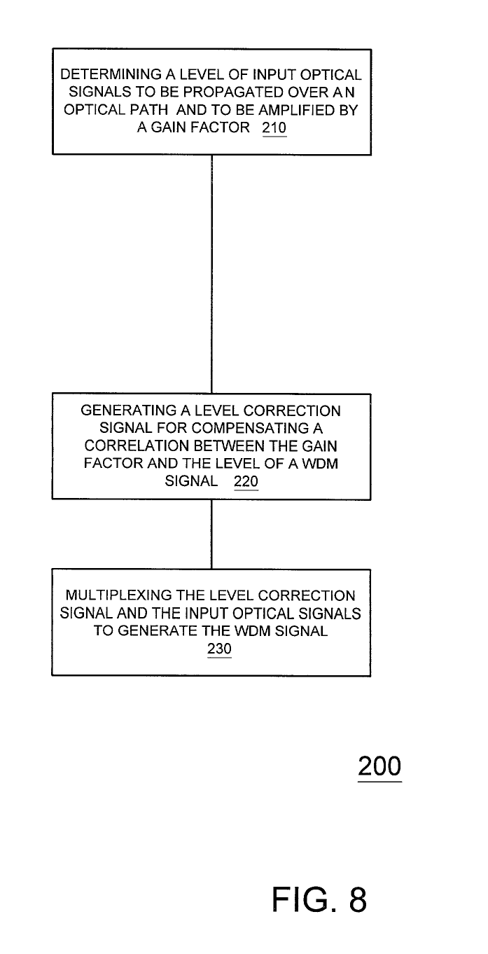

FIG. 8 illustrates method 200 for generating a wavelength division multiplexed (WDM) signal to be propagated over an optical path and to be optically amplified by a gain factor. Method 200 starts at step 210 of determining a level of input optical signals of different wavelengths to be multiplexed and sent over the optical path. Referring to FIG. 7, when optical signals arrive to optical dividers 184 and 183, they partially divided so that a portion of each arriving optical signal is provided to optical detectors 182 and 181 while another portion, referred to as input optical signals propagate to combiner 52. Optical detectors 181 and 182 convert the portion to electrical signal representative of the level of the input optical signals. The electrical signals are provided to level controller 166 that determines the cumulative level of the input optical signals.

Step 210 is followed by step 220 of generating a level correction signal, for compensating for a correlation between the gain factor and the level of the WDM signal. Referring to FIG. 7, level controller 166 calculated which level correction signal will compensate for a correlation between the gain factor and the level of the WDM signal to be outputted from combiner 53. Assuming that the compensation is guaranteed by providing a WDM signal having a constant level, level controller subtracts from this constant level the cumulative level of the input optical signals to determine the cumulative level of all the components of the level correction signal. Assuming that level correction generator is capable of generating level correction signal such as the level correction signal illustrated at FIG. 3, level controller 166 provides level correction signal generator 42 control signals that determine the level of the level correction signal. Conveniently, even at the absence of optical signals, level correction signals are provided to combiner 52 in order to reduce the amplification of noise signals.

Assuming that the level correction generator is capable of generating level correction signal that include components that utilize the same wavelengths as the input optical signals, level processor 166 can detect the non-active wavelength, and provide level correction signal generator 42 control signals so that at least some of the components of the level correction signal utilize the non active wavelengths. These components must have different characteristics that input optical signals, so that they can be differentiate from them. Usually these components have a unique pattern, and are commonly refereed to as IDLE cells.

Step 220 is followed by step 230 of multiplexing the level correction signal and the optical signals to generate the WDM signal. Referring to FIG. 7, the level correction signal is provided from level correction signal generator 42 to combiner 52 and input optical signals are provided from optical divider 184 and 182 to combiner 52 to be multiplexed to generate a WDM signal. Conveniently, step 210 is followed by a step of delaying the input optical signals outputted from optical dividers 184 and 183 until step 220 ends, such that the input optical signals and the level correction signals arrive at the same time to combiner 52.

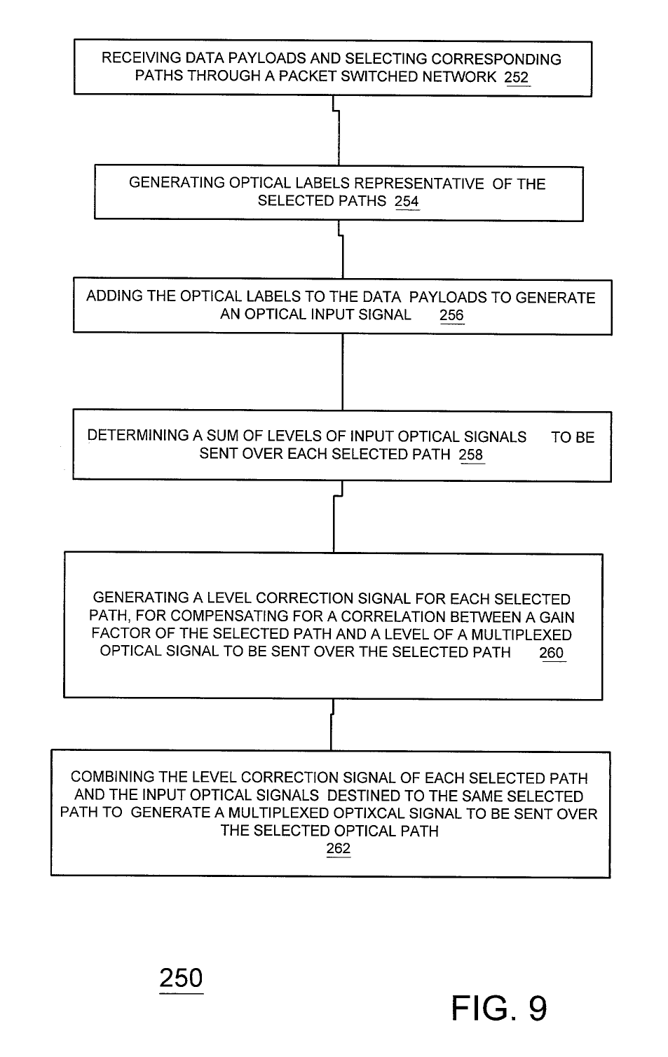

FIG. 9 illustrates method 250 for propagating data payloads from an input node to an output node in a packet switching network, the data payloads being associated to destination addresses, the packet switched network having a plurality of nodes interconnected by links.

Method 250 starts by step 252 of receiving data payloads and selecting corresponding paths through the packet switching network; the selected routs begin at selected links. Referring to the example set forth at FIG. 2, intermediate module 36 receives data payloads associated to destination address, it accesses a routing data base and selects a selected path through network 10 to each data payload.

Step 252 is followed by step 254 of generating optical labels representative of the selected paths. Referring to the example set forth in FIG. 2, intermediate module 36 selects an optical label representative of the selected path.

Step 254 is followed by step 256 of adding the optical labels to the data payloads, each pair of data payload and associated optical label embedded in the same wavelength to generate an input optical signal. Referring to the example set forth in FIG. 2, intermediate module can delay the generation of the input optical signal until it is allowed to send the input optical signal to optical switch 34.

Step 264 is followed by step 258 of determining a sum of levels of input optical signals to be sent over each selected path. Referring to the example set forth in FIG. 2, the level of input signals generated by intermediate module 36 and their destination is known to controller 41 that controls their generation and propagation. Controller 41 also receives electrical signals from optical detectors and delayers 31, 35 and 37 representative of the level of input optical signals passing through them and of the label of each input optical signal. Accordingly, controller can determine a cumulative level of input signals to be sent to each optical path.

Step 258 is followed by step 260 of generating a level correction signal, for each selected path for compensating for a correlation between a gain factor of the selected path and a level of a multiplexed optical signal to be sent over the selected path. Referring to FIG. 7, controller 41 calculated which level correction signal will compensate for a correlation between the gain factor and the level of the WDM signal to be outputted from each combiner out of combiners 52, 53 and 54.

Step 260 is followed by step 262 of combining the level correction signal of each selected path with the input signals destined to the selected path to generate a multiplexed optical signal. Referring to FIG. 7, level correction signals are provided to combiners 52, 53 and 54 with the input optical signals destined to optical paths starting at these combiners.

It will be apparent to those skilled in the art that the disclosed subject matter may be modified in numerous ways and may assume many embodiments other then the preferred form specifically set out and described above.

Accordingly, the above disclosed subject matter is to be considered illustrative and not restrictive, and to the maximum extent allowed by law, it is intended by the appended claims to cover all such modifications and other embodiments, which fall within the true spirit and scope of the present invention.

The scope of the invention is to be determined by the broadest permissible interpretation of the following claims and their equivalents rather then the foregoing detailed description.

We claim

1. A method for generating a wavelength division multiplexed (WDM) signal to be propagated over an optical path and to optically amplified by a gain factor, the method comprising the step of:
(a) determining a level of input optical signals of different wavelengths to be multiplexed and sent over the optical path;
(b) generating a level correction signal, for compensating for a correlation between the gain factor and the level of the WDM signal; and
(c) multiplexing the level correction signal and the optical signals to generate the WDM signal.

2. The method of claim 1 wherein a level of the level correction signal is inversely proportional to the sum of the levels of the input optical signals.

3. The method of claim 1 wherein an average level of the level correction signal during a time period equal to the period of the WDM signal is inversely proportional to the sum of the levels of the input optical signals.

4. The method of claim 1 wherein the level correction signal has at least one wavelength that differs from the wavelengths of each of the input optical signals.

5. The method of claim 1 wherein a wavelength band of the optical path comprises of a first band including all wavelengths of the input optical signals and at least one additional wavelength.

6. The method of claim 1 wherein step 1(a) further comprising a step of monitoring a plurality of predetermined wavelengths corresponding to possible wavelengths of input optical signals to detect a non-active wavelength, and wherein step 1(b) comprises a step of utilizing the non active wavelength to convey the level correction signal.

7. The method of claim 1 wherein the level correction signal has different characteristics from the characteristics of input optical signals for allowing for differentiating the level correction signal from input optical signals.

8. The method of claim 1 wherein the level correction signal comprises of predetermined symbols that are being discarded at an end of the optical path.

9. The method of claim 1 wherein the level of each input optical signal is constant and the level correction signal compensates for a correlation between the gain factor and between a number of input optical signals within the WDM signal.

10. The method of claim 1 wherein each input optical signal carries at least a portion of a data packet.

11. The method of claim 1 wherein at least some of the input optical signals are characterized by ultra high bit rate.

12. The method of claim 1 wherein step 1(a) further comprises a step of determining an absence of optical signals, and step 1(b) further comprises a step of generating a level correction signal such that the amplification of noise signal propagating over the optical path is minimized.

13. The method of claim 1 further comprises a step of delaying the input optical signals while determining the level of the input optical signals and while generating the level correction signal.

14. A method for generating a wavelength division multiplexed (WDM) signal to be propagated over an optical path and to optically amplified by a gain factor, the method comprising the step of:
(a) determining a level of input optical signals of different wavelengths to be multiplexed and sent over the optical path;
(b) generating at least one level correction signal, for compensating for a dependency of the gain factor on the level of the WDM signal; and
(c) multiplexing the at least one level correction signal and the optical signals to generate the WDM signal.

15. A method for generating a wavelength division multiplexed (WDM) signal to be optically amplified by a gain factor and to be propagated over an optical path, the method comprising the step of:
(a) monitoring a level of input optical signals at an input interface to determine a the levels of input optical signals of different wavelengths to be multiplexed and sent over the optical path;
(b) generating a level correction signal, for compensating for a correlation between the gain factor and the level of the WDM signal; and
(c) multiplexing the level correction signal and the optical signals to generate the WDM signal.

16. The method of claim 15 further comprising a step of discarding input level correction signals received at the input interface.

17. A method for generating an output optical signal that has a level correction component, the method comprising the steps of:
(a) monitoring a quantity of input optical signals, each of substantially predetermined equal level, at an input interface;
(b) generating a level correction signal, for compensating for a correlation between a gain factor and between a level of the output optical signal;
(c) multiplexing the input optical signals and the level correction signal to generate the output optical signal;
(d) propagating the output optical signal over an optical path to be optically amplified by the gain factor.

18. The method of claim 17 further comprising a step of discarding input level correction signals received at the input interface.

19. The method of claim 17 wherein the level of the level correction signal is inversely proportional to a sum of the levels of the input optical signals.

20. The method of claim 17 wherein the level correction signal has a wavelength that differs from all the wavelengths of the input optical signals.

21. The method of claim 17 wherein the level of the output optical signal is constant.

22. A method for propagating data payloads from an input node to an output node in a packet switching network, the data payloads being associated to destination addresses, the packet switched network having a plurality of nodes interconnected by links, the method comprising the steps of:
(a) receiving data payloads and selecting corresponding optical paths through the packet switching network;
(b) generating optical labels representative of the selected paths;
(c) adding the optical labels to the data payloads, each pair of data payload and associated optical label embedded in the same wavelength to generate an input optical signal;
(d) determining a sum of levels of input optical signals to be sent over each selected path;
(e) generating a level correction signal, for each selected path for compensating for a correlation between a gain factor of the selected path and a level of a multiplexed optical signal to be sent over the selected path; and
(f) multiplexing the level correction signal of each selected path with the input signals destined to the selected path to generate a multiplexed optical signal to be propagated over the selected path.

23. The method of claim 22 wherein step 23(a) further comprises a step of receiving input optical signals comprising of data payloads and labels.

24. The method of claim 22 further comprises a step of receiving arriving WDM signals having level correction signals, extracting the level corrections signals to generate optical input signals.

25. A method for generating a wavelength division multiplexed (WDM) signal, the method comprising the steps of:
(a) determining a quantity of input optical signals of different wavelengths and of substantially an equal level to be multiplexed and sent over the optical path;
(b) generating at least one level correction signal, for compensating for a dependency of the gain factor on the level of the WDM signal;
(c) multiplexing the at least one level correction signal and the optical signals to generate the WDM signal; and
(d) propagating the WDM signal over an optical path and optically amplifying the WDM signal by the gain factor.

26. A method for generating a wavelength division multiplexed (WDM) signal to be to be sent to an optical amplifier to be optically amplified by a gain factor, the method comprising the step of:
(a) determining levels of input optical signals of different wavelengths;
(b) generating a level correction signal, for compensating for a dependency of the gain factor on the levels of the WDM signal; and
(c) multiplexing the level correction signal and the input optical signals to generate the WDM signal.

27. A method for generating an output optical signal having a level correction component, the method comprising the steps of:
(a) monitoring a quantity of input optical signals, each of substantially a predetermined level, at an input interface;
(b) generating a level correction signal, for compensating for a correlation between a gain factor and between a level of the output optical signal; and
(c) multiplexing the input optical signals and the level correction signal to generate the output optical signal; and
(d) optically amplifying the output optical signal by the gain factor.

28. A method for generating a wavelength division multiplexed (WDM) signal to be optically amplified by a gain factor and to be propagated over an optical path, the method comprising the step of:
(a) determining a level of input optical signals of different wavelengths to be multiplexed and sent over the optical path;
(b) generating a level correction signal, for compensating for a dependency of the gain factor on the level of the WDM signal; and
(c) multiplexing the level correction signal and the input optical signals to generate the WDM signal.

29. In a network node having an input interface for receiving arriving optical signals , the network node being interconnected to a plurality of optical paths, a method for generating wavelength division multiplexed (WDM) signals, each WDM signal to be propagated over a selected optical path and to be optically amplified by a gain factor, the method comprising the step of:
(a) receiving arriving optical signals comprising of input optical signals, each input optical signal associated to a destination address;
(b) determining the level of each input optical signal;
(c) selecting optical paths to convey the input optical signals, based upon the destination address of each input optical signal;
(d) generating a level correction signal for each optical path, each level correction signal for compensating for a correlation between the gain factor and the level an WDM signal to be sent over the selected optical path; and
(e) multiplexing the level correction signal and the optical signals to be sent to each optical path to generate the WDM signals.

30. The method of claim 29 wherein a level of each level correction signal is inversely proportional to the sum of the levels of the input optical signals to be sent to a single selected optical path.

31. The method of claim 29 wherein each level correction signal has at least one wavelength that differs from the wavelengths of each of the input optical signals to be sent to the same selected optical path.

32. The method of claim 29 wherein a wavelength band of each optical path comprises of a first band including all wavelengths of the input optical signals and of at least one additional wavelength.

33. The method of claim 29 wherein step 29(b) further comprising a step of monitoring a plurality of predetermined wavelengths corresponding to possible wavelengths of input optical signals to detect a non-active wavelength, and wherein step 29(d) comprises a step of utilizing the non active wavelength to convey the level correction signal.

34. The method of claim 29 wherein the level correction signal has different characteristics from the characteristics of input optical signals for allowing to differentiate the level correction signal from input optical signals.

35. The method of claim 29 wherein the level correction signal comprises of predetermined symbols that are being discarded at an end of each optical path.

36. The method of claim 29 wherein the level of each input optical signal is constant and the level correction signal compensates for a correlation between the gain factor and between a number of input optical signals within the WDM signal.

37. The method of claim 29 wherein each input optical signal carries at least a portion of a data packet.

38. The method of claim 29 wherein at least some of the input optical signals are characterized by ultra high bit rate.

39. The method of claim 29 wherein step 29(b) further comprises a step of determining an absence of input optical signals, and step 29(d) further comprises a step of generating a level correction signal such that the amplification of noise signal propagating over the optical path is minimized.

40. The method of claim 29 further comprises a step of delaying the input optical signals so that the input optical signals and corresponding level correction signals are multiplexed.

41. An apparatus for generating a wavelength division multiplexed signal to be propagated over an optical path and to be optically amplified by a gain factor, the apparatus comprising:
an input interface, for receiving arriving optical signals,
optical dividers, coupled to the input interface, for partially dividing the arriving optical signals to output a first portion and an input optical signal;
photoelectric converters, coupled to the optical dividers, for converting the first portions of the arriving optical signals to electric signals being indicative of the levels of the input optical signals and of the destination of the input optical signals;
a level correction generator, responsive to control signals from a controller, for generating a level correction signal;
a controller, for receiving the electrical signals, determining a level correction signal and providing control signals to the level correction signal generator based upon the determination; and
a multiplexer, coupled to the optical path and to the controller, for receiving and multiplexing the input optical signals and the level correction signal to generate the WDM signal.

42. The apparatus of claim 41 wherein the level correction generator selected from the group consisting of:
tunable optical signal generator;
optical signal generator coupled to an tunable attenuator; and
a plurality of switched optical signal generators coupled to a combiner.

43. The apparatus of claim 41 wherein a level of the level correction signal is inversely proportional to the sum of the levels of the input optical signals.

44. The apparatus of claim 41 wherein an average level of the level correction signal during a time period equal to the period of the WDM signal is inversely proportional to the sum of the levels of the input optical signals.

45. The apparatus of claim 41 wherein the level correction signal has at least one wavelength that differs from the wavelengths of each of the input optical signals.

46. The apparatus of claim 41 wherein a wavelength band of the optical path comprises of a first band including all wavelengths of the input optical signals and at least one additional wavelength.

47. The apparatus of claim 41 wherein the controller is further adapted to analyze the electrical signals to detect non-active wavelengths, and to send the level correction signal generator control signals for generating level correction signals of non-active wavelengths.

48. The apparatus of claim 41 wherein the level correction signal has different characteristics from the characteristics of input optical signals for allowing to differentiate the level correction signal from input optical signals.

49. The apparatus of claim 41 wherein the level correction signal comprises of predetermined symbols that are being discarded at an end of the optical path.

50. The apparatus of claim 41 wherein the level of each input optical signal is constant and the level correction signal compensates for a correlation between the gain factor and between a number of input optical signals within the WDM signal.

51. The apparatus of claim 41 wherein each input optical signal carries at least a portion of a data packet.

52. The apparatus of claim 41 wherein at least some of the input optical signals are characterized by ultra high bit rate.

53. The apparatus of claim 41 further comprises delay units of delaying the input optical signals until the level correction signals are generated.

54. An apparatus for generating wavelength division multiplexed signals to be propagated over optical paths to be optically amplified by a gain factor, the apparatus comprising:
an input interface, for receiving arriving optical signals comprising of input optical signals, each input optical signal destined to an optical path out of a plurality of optical paths extending from the apparatus;
optical dividers, coupled to the input interface, for partially dividing arriving optical signals to output a first portions and input optical signals;
photoelectric converters, coupled to the optical dividers, for converting the first portions of the arriving optical signals to electric signals being indicative of the levels of the input optical signals and of the destination of the input optical signals;
optical switch, coupled to the optical dividers and to a control unit, for receiving the input optical signals and in response to control signals from the control unit routing the input optical signals to the destined optical paths;
a level correction generator, responsive to control signals from a control unit, for generating level correction signals;
control means for receiving the electrical signals, selecting selected paths for the input optical signals, determining for each optical path a level correction signal and providing control signals to the optical switch and the level correction signal generator based upon the determination; and
a plurality of multiplexers, each multiplexer coupled to an optical path for receiving and multiplexing input optical signals and a corresponding level correction signal destined to the optical path for generating the WDM signal.

55. The apparatus of claim 54 wherein the level correction generator selected from the group consisting of:
tunable optical signal generator;
optical signal generator coupled to an tunable attenuator; and
a plurality of switched optical signal generators coupled to a combiner.
